(19) United States
(12) Patent Application Publication
(10) Pub. No.: US 2025/0225376 A1
(43) Pub. Date: Jul. 10, 2025

(54) Multimodal Data Loss Protection using artificial intelligence

(71) Applicant: Zscaler, Inc., San Jose, CA (US)

(72) Inventors: Chenhui Hu, Boston, MA (US); Kabir Nagpal, Bengaluru (IN); Miao Zhang, Sunnyvale, CA (US); Rex Shang, Los Altos, CA (US); Jacob Bollinger, San Francisco, CA (US); Arun Bhallamudi, Fremont, CA (US); Claudionor Jose Nunes Coelho, JR., Redwood City, CA (US); Sanjay Kalra, San Jose, CA (US)

(73) Assignee: Zscaler, Inc., San Jose, CA (US)

(21) Appl. No.: 18/584,354

(22) Filed: Feb. 22, 2024

(30) Foreign Application Priority Data
Jan. 10, 2024 (IN) 202441001852

(51) Int. Cl. G06N 3/0455; G06N 3/096

(52) U.S. Cl. CPC G06N 3/0455; G06N 3/096

(57) ABSTRACT

Multimodal Data Loss Protection (DLP) includes receiving an input comprising data in any of a plurality of formats; processing the input to determine whether or not the data includes sensitive data; and responsive to the input including sensitive data, performing steps of: processing the input to classify the input into a category of a plurality of categories; and providing an indication of the category of the plurality of categories. Advantageously, the trained multimodal system can detect categories of data being accessed, transferred, etc., without the requirement of up-front dictionaries from corporate Information Technology (IT).

### FIELD OF THE DISCLOSURE

The present disclosure generally relates to computer networking systems and methods, particularly focused on securing sensitive data. More particularly, the present disclosure relates to systems and methods for multimodal Data Loss Protection (DLP) using artificial intelligence, such as machine learning.

### BACKGROUND OF THE DISCLOSURE

In computing, networking, Information Technology (IT), cybersecurity, and the like, Data Loss Protection (DLP), also referred to as Data Loss Prevention, simply Data Protection (when referring to the protection aspect) or simply Data Loss (when referring to the detection aspect or the problem itself), relates to various aspects protecting sensitive corporate data. Of course, a corporation or any organization's data is one of its most important assets and any loss or theft has significant economic exposure. Corporate data can be leaked in different ways, i.e., through email, web mail, cloud storage, social media, and a variety of other applications, as well as simply attaching storage devices and copying files. Companies can set up a policy using predefined templates (e.g. regular expression matching) for sensitive data formats to avoid data breaches. For example, some existing approaches for DLP are described in commonly-assigned U.S. Pat. No. 11,829,347, issued Nov. 28, 2023, and entitled “Cloud-based data loss prevention,” the contents of which are incorporated by reference in their entirety. These approaches generally require the company to provide a dictionary and the detection techniques include Exact Data Matching (EDM), where specific keywords, classes of data, etc. are flagged, or Indexed Data Matching (IDM), where content that matches the whole or some part of a document from a repository of documents is flagged, along with possible Optical Character Recognition (OCR) to get any text from images. While these approaches are effective in securing data, they require up front input (i.e., the dictionaries) and can be overly restrictive or may miss certain crucial files because of challenges in comprehending the combination of various file formats (e.g., images, text, video, etc.). There is a need in DLP to detect potential data loss without specifying the data up front, without sharing sensitive data, and with an ability to detect across different modes.

### BRIEF SUMMARY OF THE DISCLOSURE

The present disclosure relates to systems and methods for multimodal Data Loss Protection (DLP) using artificial intelligence. In particular, the approach is multimodal in that it can understand or generate information across multiple modes or types of data (e.g., text, image, video, audio, etc.). The present disclosure utilizes artificial intelligence and machine learning, where a trained multimodal system can process and integrate information from various modalities, i.e., text, images, sound, video and more. Advantageously, the trained multimodal system can detect categories of data being accessed, transferred, etc., without the requirement of up-front dictionaries from corporate IT. The trained multimodal system can be the tool to empower data loss prevention.

In various embodiments, the present disclosure includes a computer-implemented method for multimodal Data Loss Protection (DLP) having steps, a cloud service configured to implement the steps, a server or any other processing device configured to implement the steps, and a non-transitory computer-readable medium storing instructions that, when executed, cause one or more processors to execute the steps. The steps include receiving an input comprising data in any of a plurality of formats; processing the input to determine whether or not the data includes sensitive data; and, responsive to the input including sensitive data, performing steps of processing the input to classify the input into a category of a plurality of categories; and providing an indication of the category of the plurality of categories. The steps can further include, responsive to the input including non-sensitive data, providing an indication the data is non-sensitive, thereby either allowing the data in transit or not marking the data at rest.

The steps can further include, responsive to the input including sensitive data, providing an indication of the category of the plurality of categories and a sub-category associated with the category. The plurality of formats can include text formats, image formats, audio formats, video formats, source code, and a combination thereof. The processing the input to determine whether or not the data includes sensitive data can utilize (1) a Large Language Model (LLM) and embeddings and (2) a machine learning model configured for classification. The processing the input to classify the input into the category can utilize (1) a Large Language Model (LLM) and (2) a zero-shot classifier.

The processing the input to determine whether or not the data includes sensitive data and the processing the input to classify the input into the category both can utilize one or more machine learning models that were trained based on a set of training documents with labels. The steps can further include, prior to training the one or more machine learning models with the set of training documents with labels, identifying any mislabeled documents therein by performing Optical Character Recognition (OCR) and checking if associated keywords are present. The steps can further include, prior to training the one or more machine learning models with the set of training documents with labels, filtering out an images in the set of training documents with labels based on file size. The steps can further include, prior to training the one or more machine learning models with the set of training documents with labels, grouping images in the set of training documents with subtle differences based on a hash of the images.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a network diagram of three example network configurations of cybersecurity monitoring of a user.

FIG. 1B is a logical diagram of the cloud from FIG. 1A operating as a zero-trust platform.

FIG. 2 is a block diagram of a server.

FIG. 3 is a block diagram of a user device.

FIG. 4 is a diagram of a multimodal DLP system for analyzing different input file formats with various tool.

FIG. 5 is a screenshot of an example output of the a multimodal DLP system of FIG. 4.

FIG. 6 is a flowchart of a multimodal DLP with artificial intelligence process.

FIG. 7 is a screenshot of three sample images that are closely similar to one another.

FIG. 8 is a flowchart of a process for an example implementation of the sensitive data classifier step of the multimodal DLP with artificial intelligence process of FIG. 6 using a combination of an LLM and zero-shot classifiers.

FIG. 9 is a flowchart of a process 500 for an example implementation of the sensitive content identifier of the multimodal DLP with artificial intelligence process of FIG. 6 using a combination of CLIP embedding and supervised learning XGboost.

FIG. 10 is a table of example of categorization results using the process of FIG. 9.

FIG. 11 is a table of examples of sub-category results.

FIG. 12 is a flowchart of a process for multimodal DLP.

### DETAILED DESCRIPTION OF THE DISCLOSURE

Again, the present disclosure relates to systems and methods for multimodal Data Loss Protection (DLP) using artificial intelligence.

### § 1.0 Cybersecurity Monitoring and Protection Examples

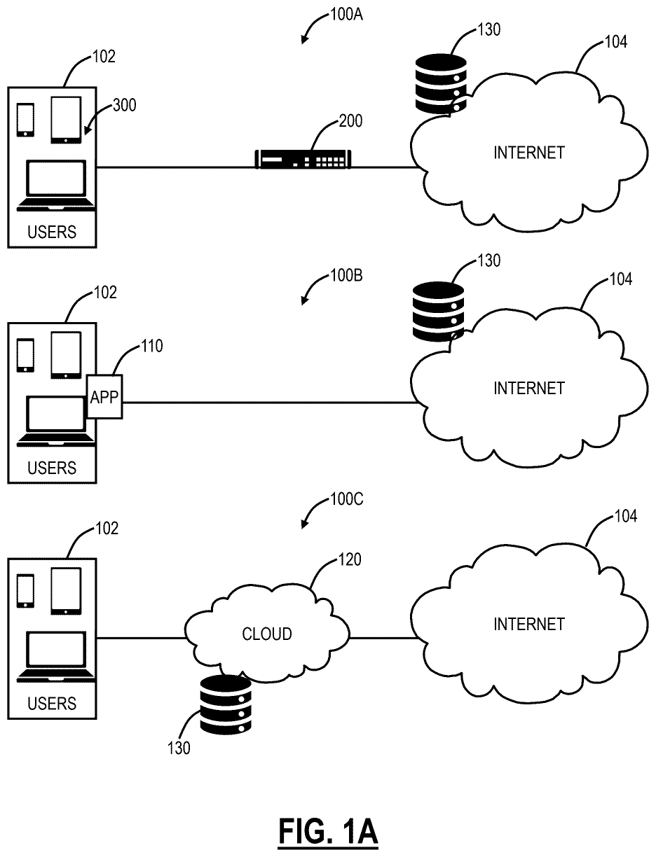

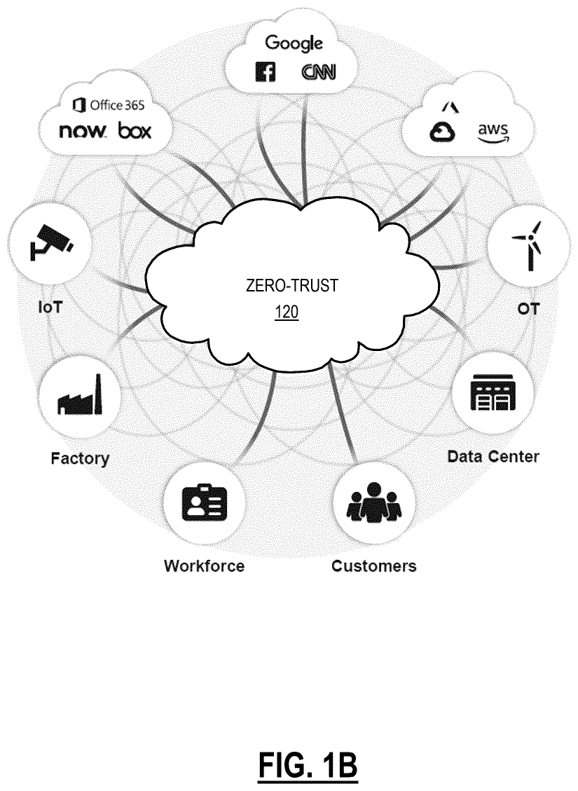

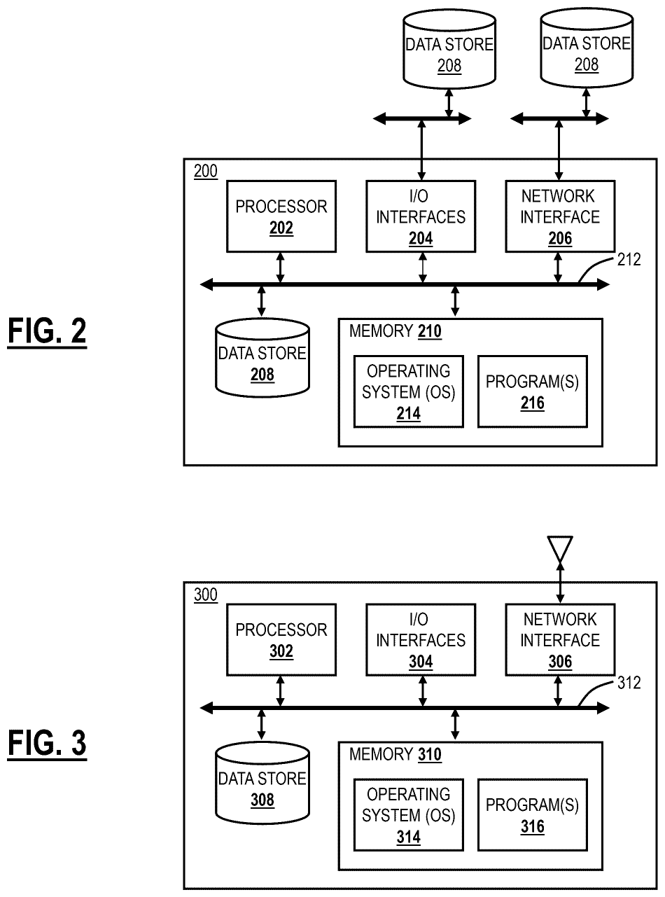

FIG. 1A is a network diagram of three example network configurations 100A, 100B, 100C of cybersecurity monitoring and protection of a user 102. Those skilled in the art will recognize these are some examples for illustration purposes, there may be other approaches to cybersecurity monitoring, and these various approaches can be used in combination with one another as well as individually. Also, while shown for a single user 102, practical embodiments will handle a large volume of users 102, including multi-tenancy. In this example, the user 102 (having a user device 300 such as illustrated in FIG. 3) communicates on the Internet 104, including accessing cloud services, Software-as-a-Service, etc. (each may be offered via compute resources, such as using one or more servers 200 as illustrated in FIG. 2). As part of offering cybersecurity through these example network configurations 100A, 100B, 100C, there is a large amount of cybersecurity data obtained. The present disclosure focuses on using this cybersecurity data for various purposes.

The network configuration 100A includes a server 200 located between the user 102 and the Internet 104. For example, the server 200 can be a proxy, a gateway, a Secure Web Gateway (SWG), Secure Internet and Web Gateway, Secure Access Service Edge (SASE), Secure Service Edge (SSE), Cloud Application Security Broker (CASB), etc. The server 200 is illustrated located inline with the user 102 and configured to monitor the user 102. In other embodiments, the server 200 does not have to be inline. For example, the server 200 can monitor requests from the user 102 and responses to the user 102 for one or more security purposes, as well as allow, block, warn, and log such requests and responses. The server 200 can be on a local network associated with the user 102 as well as external, such as on the Internet 104. The network configuration 100B includes an application 110 that is executed on the user device 300. The application 110 can perform similar functionality as the server 200, as well as coordinated functionality with the server 200. Finally, the network configuration 100C includes a cloud service 120 configured to monitor the user 102 and perform security-as-a-service. Of course, various embodiments are contemplated herein, including combinations of the network configurations 100A, 100B, 100C together.

The cybersecurity monitoring and protection can include firewall, intrusion detection and prevention, Uniform Resource Locator (URL) filtering, content filtering, bandwidth control, Domain Name System (DNS) filtering, protection against advanced threat (malware, spam, Cross-Site Scripting (XSS), phishing, etc.), data protection, sandboxing, antivirus, and any other security technique. Any of these functionalities can be implemented through any of the network configurations 100A, 100B, 100C. A firewall can provide Deep Packet Inspection (DPI) and access controls across various ports and protocols as well as being application and user aware. The URL filtering can block, allow, or limit website access based on policy for a user, group of users, or entire organization, including specific destinations or categories of URLs (e.g., gambling, social media, etc.). The bandwidth control can enforce bandwidth policies and prioritize critical applications such as relative to recreational traffic. DNS filtering can control and block DNS requests against known and malicious destinations.

The intrusion prevention and advanced threat protection can deliver full threat protection against malicious content such as browser exploits, scripts, identified botnets and malware callbacks, etc. The sandbox can block zero-day exploits (just identified) by analyzing unknown files for malicious behavior. The antivirus protection can include antivirus, antispyware, antimalware, etc. protection for the users 102, using signatures sourced and constantly updated. The DNS security can identify and route command-and-control connections to threat detection engines for full content inspection. The DLP can use standard and/or custom dictionaries to continuously monitor the users 102, including compressed and/or Secure Sockets Layer (SSL)-encrypted traffic.

In some embodiments, the network configurations 100A, 100B, 100C can be multi-tenant and can service a large volume of the users 102. Newly discovered threats can be promulgated for all tenants practically instantaneously. The users 102 can be associated with a tenant, which may include an enterprise, a corporation, an organization, etc. That is, a tenant is a group of users who share a common grouping with specific privileges, i.e., a unified group under some IT management. The present disclosure can use the terms tenant, enterprise, organization, enterprise, corporation, company, etc. interchangeably and refer to some group of users 102 under management by an IT group, department, administrator, etc., i.e., some group of users 102 that are managed together. One advantage of multi-tenancy is the visibility of cybersecurity threats across a large number of users 102, across many different organizations, across the globe, etc. This provides a large volume of data to analyze, use artificial intelligence techniques on, develop comparisons, etc.

Of course, the cybersecurity techniques above are presented as examples. Those skilled in the art will recognize other techniques are also contemplated herewith. That is, any approach to cybersecurity that can be implemented via any of the network configurations 100A, 100B, 100C. Also, any of the network configurations 100A, 100B, 100C can be multi-tenant with each tenant having its own users 102 and configuration, policy, rules, etc.

### § 1.1 Cloud Monitoring

The cloud 120 can scale cybersecurity monitoring and protection with near-zero latency on the users 102. Also, the cloud 120 in the network configuration 100C can be used with or without the application 110 in the network configuration 100B and the server 200 in the network configuration 100A. Logically, the cloud 102 can be viewed as an overlay network between users 102 and the Internet 104 (and cloud services, SaaS, etc.). Previously, the IT deployment model included enterprise resources and applications stored within a data center (i.e., physical devices) behind a firewall (perimeter), accessible by employees, partners, contractors, etc. on-site or remote via Virtual Private Networks (VPNs), etc. The cloud 120 replaces the conventional deployment model. The cloud 120 can be used to implement these services in the cloud without requiring the physical appliances and management thereof by enterprise IT administrators. As an ever-present overlay network, the cloud 120 can provide the same functions as the physical devices and/or appliances regardless of geography or location of the users 102, as well as independent of platform, operating system, network access technique, network access provider, etc.

There are various techniques to forward traffic between the users 102 and the cloud 120. A key aspect of the cloud 120 (as well as the other network configurations 100A, 100B) is all traffic between the users 102 and the Internet 104 is monitored. All of the various monitoring approaches can include log data 130 accessible by a management system, management service, analytics platform, and the like. For illustration purposes, the log data 130 is shown as a data storage element and those skilled in the art will recognize the various compute platforms described herein can have access to the log data 130 for implementing any of the techniques described herein for risk quantification. In an embodiment, the cloud 120 can be used with the log data 130 from any of the network configurations 100A, 100B, 100C, as well as other data from external sources.

The cloud 120 can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud 120 contemplates implementation via any approach known in the art.

The cloud 120 can be utilized to provide example cloud services, including Zscaler Internet Access (ZIA), Zscaler Private Access (ZPA), Zscaler Workload Segmentation (ZWS), and/or Zscaler Digital Experience (ZDX), all from Zscaler, Inc. (the assignee and applicant of the present application). Also, there can be multiple different clouds 120, including ones with different architectures and multiple cloud services. The ZIA service can provide the access control, threat prevention, and data protection. ZPA can include access control, microservice segmentation, etc. The ZDX service can provide monitoring of user experience, e.g., Quality of Experience (QoE), Quality of Service (QOS), etc., in a manner that can gain insights based on continuous, inline monitoring. For example, the ZIA service can provide a user with Internet Access, and the ZPA service can provide a user with access to enterprise resources instead of traditional Virtual Private Networks (VPNs), namely ZPA provides Zero Trust Network Access (ZTNA). Those of ordinary skill in the art will recognize various other types of cloud services are also contemplated.

### § 1.2 Zero Trust

FIG. 1B is a logical diagram of the cloud 120 operating as a zero-trust platform. Zero trust is a framework for securing organizations in the cloud and mobile world that asserts that no user or application should be trusted by default. Following a key zero trust principle, least-privileged access, trust is established based on context (e.g., user identity and location, the security posture of the endpoint, the app or service being requested) with policy checks at each step, via the cloud 120 Zero trust is a cybersecurity strategy wherein security policy is applied based on context established through least-privileged access controls and strict user authentication—not assumed trust. A well-tuned zero trust architecture leads to simpler network infrastructure, a better user experience, and improved cyberthreat defense.

Establishing a zero-trust architecture requires visibility and control over the environment's users and traffic, including that which is encrypted; monitoring and verification of traffic between parts of the environment; and strong multifactor authentication (MFA) methods beyond passwords, such as biometrics or one-time codes. This is performed via the cloud 120. Critically, in a zero-trust architecture, a resource's network location is not the biggest factor in its security posture anymore. Instead of rigid network segmentation, your data, workflows, services, and such are protected by software-defined micro segmentation, enabling you to keep them secure anywhere, whether in your data center or in distributed hybrid and multi-cloud environments.

The core concept of zero trust is simple: assume everything is hostile by default. It is a major departure from the network security model built on the centralized data center and secure network perimeter. These network architectures rely on approved IP addresses, ports, and protocols to establish access controls and validate what's trusted inside the network, generally including anybody connecting via remote access VPN. In contrast, a zero-trust approach treats all traffic, even if it is already inside the perimeter, as hostile. For example, workloads are blocked from communicating until they are validated by a set of attributes, such as a fingerprint or identity. Identity-based validation policies result in stronger security that travels with the workload wherever it communicates—in a public cloud, a hybrid environment, a container, or an on-premises network architecture.

Because protection is environment-agnostic, zero trust secures applications and services even if they communicate across network environments, requiring no architectural changes or policy updates. Zero trust securely connects users, devices, and applications using business policies over any network, enabling safe digital transformation. Zero trust is about more than user identity, segmentation, and secure access. It is a strategy upon which to build a cybersecurity ecosystem.

### At its Core are Three Tenets:

Terminate every connection: Technologies like firewalls use a “passthrough” approach, inspecting files as they are delivered. If a malicious file is detected, alerts are often too late. An effective zero trust solution terminates every connection to allow an inline proxy architecture to inspect all traffic, including encrypted traffic, in real time-before it reaches its destination—to prevent ransomware, malware, and more.

Protect data using granular context-based policies: Zero trust policies verify access requests and rights based on context, including user identity, device, location, type of content, and the application being requested. Policies are adaptive, so user access privileges are continually reassessed as context changes.

Reduce risk by eliminating the attack surface: With a zero-trust approach, users connect directly to the apps and resources they need, never to networks (see ZTNA). Direct user-to-app and app-to-app connections eliminate the risk of lateral movement and prevent compromised devices from infecting other resources. Plus, users and apps are invisible to the internet, so they cannot be discovered or attacked.

### $2.0 Example Server Architecture

FIG. 2 is a block diagram of a server 200, which may be used in as a destination on the Internet, for the network configuration 100A, etc. The server 200 may be a digital computer that, in terms of hardware architecture, generally includes a processor 202, input/output (I/O) interfaces 204, a network interface 206, a data store 208, and memory 210. It should be appreciated by those of ordinary skill in the art that FIG. 2 depicts the server 200 in an oversimplified manner, and a practical embodiment may include additional components and suitably configured processing logic to support known or conventional operating features that are not described in detail herein. The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 202 is a hardware device for executing software instructions. The processor 202 may be any custom made or commercially available processor, a Central Processing Unit (CPU), an auxiliary processor among several processors associated with the server 200, a semiconductor-based microprocessor (in the form of a microchip or chipset), or generally any device for executing software instructions. When the server 200 is in operation, the processor 202 is configured to execute software stored within the memory 210, to communicate data to and from the memory 210, and to generally control operations of the server 200 pursuant to the software instructions. The I/O interfaces 204 may be used to receive user input from and/or for providing system output to one or more devices or components.

The network interface 206 may be used to enable the server 200 to communicate on a network, such as the Internet 104. The network interface 206 may include, for example, an Ethernet card or adapter or a Wireless Local Area Network (WLAN) card or adapter. The network interface 206 may include address, control, and/or data connections to enable appropriate communications on the network. A data store 208 may be used to store data. The data store 208 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 208 may incorporate electronic, magnetic, optical, and/or other types of storage media. In one example, the data store 208 may be located internal to the server 200, such as, for example, an internal hard drive connected to the local interface 212 in the server 200. Additionally, in another embodiment, the data store 208 may be located external to the server 200 such as, for example, an external hard drive connected to the I/O interfaces 204 (e.g., SCSI or USB connection). In a further embodiment, the data store 208 may be connected to the server 200 through a network, such as, for example, a network-attached file server.

The memory 210 may include any volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 210 may incorporate electronic, magnetic, optical, and/or other types of storage media. Note that the memory 210 may have a distributed architecture, where various components are situated remotely from one another but can be accessed by the processor 202. The software in memory 210 may include one or more software programs, each of which includes an ordered listing of executable instructions for implementing logical functions. The software in the memory 210 includes a suitable Operating System (O/S) 214 and one or more programs 216. The operating system 214 essentially controls the execution of other computer programs, such as the one or more programs 216, and provides scheduling, input-output control, file and data management, memory management, and communication control and related services. The one or more programs 216 may be configured to implement the various processes, algorithms, methods, techniques, etc. described herein. Those skilled in the art will recognize the cloud 120 ultimately runs on one or more physical servers 200, virtual machines, etc..

### § 3.0 Example User Device Architecture

FIG. 3 is a block diagram of a user device 300, which may be used by a user 102. Specifically, the user device 300 can form a device used by one of the users 102, and this may include common devices such as laptops, smartphones, tablets, netbooks, personal digital assistants, cell phones, e-book readers, Internet-of-Things (IoT) devices, servers, desktops, printers, televisions, streaming media devices, storage devices, and the like. The user device 300 can be a digital device that, in terms of hardware architecture, generally includes a processor 302, I/O interfaces 304, a network interface 306, a data store 308, and memory 310. It should be appreciated by those of ordinary skill in the art that FIG. 3 depicts the user device 300 in an oversimplified manner, and a practical embodiment may include additional components and suitably configured processing logic to support known or conventional operating features that are not described in detail herein. The components (302, 304, 306, 308, and 302) are communicatively coupled via a local interface 312. The local interface 312 can be, for example, but not limited to, one or more buses or other wired or wireless connections, as is known in the art. The local interface 312 can have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 can be any custom made or commercially available processor, a CPU, an auxiliary processor among several processors associated with the user device 300, a semiconductor-based microprocessor (in the form of a microchip or chipset), or generally any device for executing software instructions. When the user device 300 is in operation, the processor 302 is configured to execute software stored within the memory 310, to communicate data to and from the memory 310, and to generally control operations of the user device 300 pursuant to the software instructions. In an embodiment, the processor 302 may include a mobile-optimized processor such as optimized for power consumption and mobile applications. The I/O interfaces 304 can be used to receive user input from and/or for providing system output. User input can be provided via, for example, a keypad, a touch screen, a scroll ball, a scroll bar, buttons, a barcode scanner, and the like. System output can be provided via a display device such as a Liquid Crystal Display (LCD), touch screen, and the like.

The network interface 306 enables wireless communication to an external access device or network. Any number of suitable wireless data communication protocols, techniques, or methodologies can be supported by the network interface 306, including any protocols for wireless communication. The data store 308 may be used to store data. The data store 308 may include any volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The memory 310 may include any volatile memory elements (e.g., random access memory (RAM, such as DRAM, SRAM, SDRAM, etc.)), nonvolatile memory elements (e.g., ROM, hard drive, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 can include one or more software programs, each of which includes an ordered listing of executable instructions for implementing logical functions. In the example of FIG. 3, the software in the memory 310 includes a suitable operating system 314 and programs 316. The operating system 314 essentially controls the execution of other computer programs and provides scheduling, input-output control, file and data management, memory management, and communication control and related services. The programs 316 may include various applications, add-ons, etc. configured to provide end-user functionality with the user device 300. For example, example programs 316 may include, but not limited to, a web browser, social networking applications, streaming media applications, games, mapping and location applications, electronic mail applications, financial applications, and the like. The application 110 can be one of the example programs.

### § 4.0 Data Loss

DLP involves monitoring of an organization's sensitive data, including data at endpoint devices, data at rest (i.e., stored somewhere), and data in motion (i.e., being transmitted somewhere). DLP monitoring approaches focus on a variety of products, including software agents at endpoints, physical appliances, virtual appliances, etc. As applications move to the cloud, users are accessing them directly, everywhere they connect, inevitably leaving blind spots as users bypass security controls in conventional DLP approaches while off-network. As such, previously referenced U.S. Pat. No. 11,829,347, issued Nov. 28, 2023, and entitled “Cloud-based data loss prevention,” describes cloud-based techniques.

The present disclosure includes an artificial intelligence based approach to DLP that categorizes data into one of a plurality of categories. Those skilled in the art will recognize this approach can be used in any system architecture, including the network configurations 100A, 100B, 100C of cybersecurity monitoring and protection, variants thereof, as well as other approaches known in the art. Further, the artificial intelligence based approach can be used in combination with existing DLP approaches known in the art.

### § 4.1 Conventional DLP

Generally, all of these existing techniques utilize DLP dictionaries which include specific kinds of information in users' traffic and information as well as custom information. For example, specific kinds of information can look for types of data, e.g., Personally Identifiable Information (PII), bank information, credit card information, etc. That is, the specific information can detect something based on its format with a simple example being a social security number which is formatted as XXX-XX-XXX. The custom information can be specific keywords from a company, e.g., customer names, product names, etc. Also, the custom information can be specific documents, i.e., the sensitive information itself. That is, DLP can detect keywords, specific kinds of information, and actual documents as well as portions of actual documents.

With the dictionaries, there can be different techniques to detect this information, including Exact Data Matching (EDM) where specific keywords, classes of data, etc. are flagged. For example, DLP can detect social security numbers, credit card numbers, etc. based on the data format, such as in structured documents, etc. There can also be an approach in unstructured documents referred to as Indexed Document Matching (IDM) to identify and protect content that matches the whole or some part of a document from a repository of documents. Further, either of these approaches can be performed with Optical Character Recognition (OCR) as well to cover non-text data.

Again, these approaches work well but have a couple of disadvantages. First, these approaches require up-front dictionaries. For the specific kinds of information, DLP monitoring systems typically offer predefined dictionaries for the specific kinds of information. So, IT can preselect these dictionaries. For the repository of documents, IT has to provide this information. To address the desire to avoid sharing sensitive information, approaches provide hashing to allow detection of the sensitive information without sharing the actual sensitive information. However, a key point here is the need to provide information and/or select dictionaries in advance. One further disadvantage is these approaches tend to be overly restrictive (false positives) or miss critical information (false negatives). In the overly restrictive case, users 102 are prohibited from exchanging data that falls into a rule, e.g., blocking and reporting an email which looks like it has banking or PII information, but when this information actually belongs to the user 102. Also, new documents may be missed if they are not in the provided repository.

§ 4.2 Multimodal DLP with Artificial Intelligence

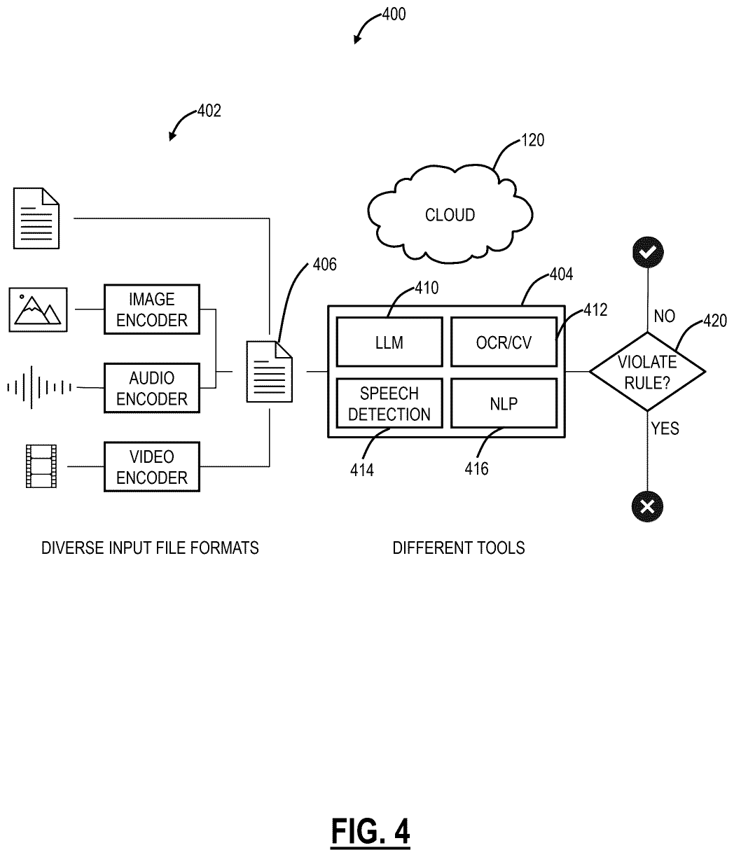

FIG. 4 is a diagram of a multimodal DLP system 400 for analyzing different input file formats 402 with various tools 404. The multimodal DLP system 400 is referred to as a system and those skilled in the art will recognize this can be implemented as a method with steps, via a non-transitory computer-readable medium with instructions that cause one or more processors to implement the steps, and via computing resources configured to implement the steps. For example, the computing resources can include the cloud 120, the server 200, the user device 300, etc.

The multimodal DLP system 400 is referred to as multimodal meaning it can understand or generate information across multiple modes or types of data. In the context of artificial intelligence and machine learning, the multimodal DLP system 400 can process and integrate information from various modalities, such as text, images, sound, video and more. Traditional DLP solutions are limited to understanding and managing text and image-based data, and the world has transitioned to a broader set of visual and audio multimedia formats. The multimodal DLP system 400 enhances the way DLP will operate by integrating generative AI and multi-modal capabilities to protect customers' data from leakage across various media formats beyond text and images, such as video and audio formats.

As such, the input file formats 402 contemplate any type of content which can be used to convey information. The input file formats 402 can be images, text, audio, video, and combinations thereof. In particular, the input file formats 402 can extend beyond anything that can be reduced to text. For example, traditional approaches look for text in images or video, such as via OCR, and for text in audio, such as via converting the audio to text. With artificial intelligence and machine learning, the DLP detection is not limited to text, but can extend to pure images and the like. That is, the output of multimodal DLP system 400 is not merely a verdict that some sensitive data is contained in a file, but rather can be to classify the type of content.

In various embodiments, the collective input file formats 402 can include, without limitation, image formats, video formats, text formats, spreadsheets, Comma Separated Values (CSV) formats, source code, presentation formats, Portable Document Format (PDF), and the like. The collective input file formats 402 can be a single input 406 to the tools 404 in the multimodal DLP system 400. The various tools 404 can include one or more Large Language Models (LLMs) 410, an OCR/Computer Vision (CV) system 412, a speech detection system 414, and a Natural Language Processing (NLP) system 416. In some embodiments, the particular tool 404 can be used based on the file format 402. In other embodiments, multiple tools 404 can be used on the same file, e.g., an audio file can be processed by the speech detection system 414 and then processed by the LLMs 410 and/or the NLP system 416. Similarly, in some embodiments, an image or video file can be processed by the OCR/CV system 412 and then processed by the LLMs 410 and/or the NLP system 416. In various embodiments, all different file formats 402 can be processed by the LLMs 410.

The present disclosure contemplates using one or more tools 404 based on the different file formats 404. In an embodiment, the following models were used in the tools 404, individually and in combination with one another:
(1) BLIP (Bootstrapping Language-Image Pre-training), see, e.g., Li, Junnan, et al. “Blip: Bootstrapping language-image pre-training for unified vision-language understanding and generation.” International Conference on Machine Learning. PMLR, 2022, the contents of which are incorporated by reference in their entirety. The BLIP model is capable of processing images.
(2) Video LLAMA (Large Language Model Meta AI), see, e.g., Zhang, Hang, Xin Li, and Lidong Bing. “Video-llama: An instruction-tuned audio-visual language model for video understanding.” arXiv preprint arXiv: 2306.02858 (2023), the contents of which are incorporated by reference in their entirety. The Video LLAMA model is capable of processing images and videos.
(3) LLaVa (Large Language and Vision Assistant), see, e.g., Liu, Haotian, et al. “Visual instruction tuning.” arXiv preprint arXiv: 2304.08485 (2023). This is a novel end-to-end trained large multimodal that combines a vision encoded and Vicuna for general purpose visual and language understanding (Vicuna is a chat assistant trained by fineOtuning LLaMA on user-shared conversation collected from ShareGTP, see, e.g., Zheng, Lianmin, et al. “Judging LLM-as-a-judge with MT-Bench and Chatbot Arena.” arXiv preprint arXiv: 2306.05685 (2023), the contents of which are incorporated by reference in their entirety).
(4) BART (Bidirectional and Auto-Regressive Transformers) zero-shot classifier. BART is pre-trained by (1) corrupting text with an arbitrary noising function, and (2) learning a model to reconstruct the original text. Zero-shot classification is a machine learning approach in which a model can classify data into multiple classes without any specific training examples for those classes.
(5) CLIP (Contrastive Language-Image Pretraining), see, e.g., Radford, Alec, et al. “Learning transferable visual models from natural language supervision.” International conference on machine learning. PMLR, 2021, the contents of which are incorporated by reference in their entirety. CLIP can predict the most relevant text snippet in a given image.

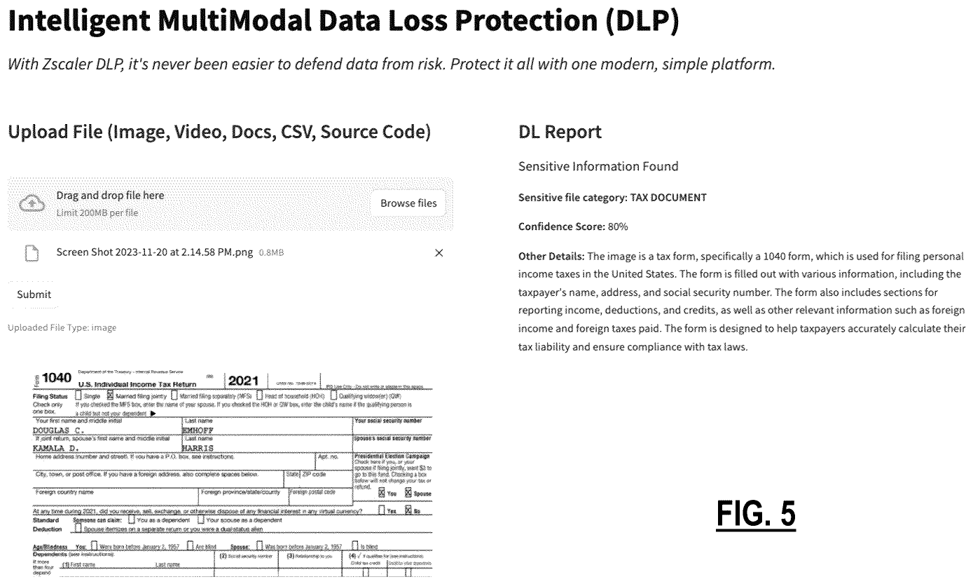

FIG. 5 is a screenshot of an example output of the a multimodal DLP system 400. FIG. 5 is presented for illustration purposes and those skilled in the art will appreciate the output can be used in the cloud 120, in any of the network configurations 100A, 100B, 100C, and the like, for various purposes, including allowing/blocking content, providing notifications and alerts, crawling cloud services for detection, etc. Here, a single file is input (e.g., image, video, docs, CSV, source code, etc.) and the tools 404 analyze the file, e.g., in this case an image-a screenshot in the form of a Portable Network Graphic (PNG) file. The output includes a classification that the information is (1) sensitive and (2) in a category or super category of a Tax document, along with a confidence score (e.g., 80%), as well as with other details, such as derived from the LLMs 410.

§ 4.3 Multimodal DLP with Artificial Intelligence Process

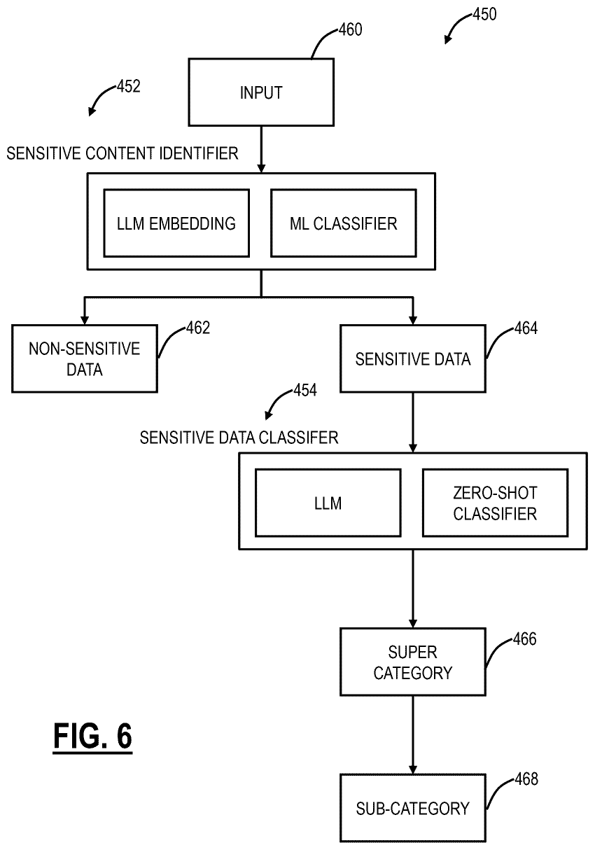

FIG. 6 is a flowchart of a multimodal DLP with artificial intelligence process 450. The process 450 contemplates implementation as a method having steps, via computing resources configured to implement the steps, and as a non-transitory computer-readable medium with instructions that when executed cause one or more processors to implement the steps. The process 450 can be implemented with the multimodal DLP system 400, and practical implementations of the multimodal DLP system 400 and the process 450 can be through the network configurations 100A, 100B, 100C, and the like. That is, the multimodal DLP system 400 and the process 450 contemplate use with any cybersecurity monitoring platform, appliance, service, etc.

The process 450 is implemented via a two-stage classifier including a sensitive content identifier step 452 and a sensitive data classifier step 454. The process 450 uses the two steps to improve the detection of sensitive data and enhance the user experience. The process 450 begins with an input (step 460). Again, the input can be some content in any file format, as well as in a combination of formats. The sensitive content identifier step 452 determines if the input has sensitive data, emphasizing precision and recall for the sensitive category to reduce false positives and false negatives. The sensitive content identifier step 452 can include use of LLM embeddings and a machine learning classifier to determine whether or not the input is sensitive (step 464) or not (step 462). The LLM embeddings are used to detect and classify objects in the inputs and the machine learning classifier can be used to classify text along with the objects. Of course, the process 450 can terminate upon determination the input is not sensitive (step 462), i.e., there is no potential data loss. As such, the sensitive content identifier step 452 enables quicker and more efficient detection.

The sensitive data classifier step 454 only needs to be performed when the input is sensitive. The sensitive data classifier step 454 organizes sensitive information into predefined categories to enhance the user experience and for reporting. For example, the sensitive data classifier step 454 can determine a super category (step 466) as well as a sub-category (step 468). For example, the super category can be financial, engineering, marketing, sales, human resources, tax, etc., i.e., a larger classification. The sub-category can be different for each super category, e.g., for financial-invoice, purchase order, purchase agreement, financial statement, bill of sale, loan agreement, etc., and the like.

The two steps 452, 454 can be used with various cybersecurity monitoring approaches. The sensitive content identifier step 452 can be a front end and in testing has shown accuracy of more than 90%. In the case of data in transit, the sensitive content identifier step 452 can be used to block/allow files. In the case of data at rest, the sensitive content identifier step 452 can be used to efficiently identify and further process sensitive data, i.e., the full detection is not needed on non-sensitive data. The sensitive data classifier step 454 can be used by IT for policy. The two steps 452, 454 can use various combinations of the tools 404, including the example machine learning models described above.

The following table provides some metrics associated with an implementation of the process 450:

| Model | precision | recall |
|---|---|---|
| Sensitive content detector | 0.95 | 0.98 |
| Sensitive data categorizer (super-category) | 0.84 | 0.85 |
| Sensitive data categorizer (sub-category) | 0.78 | 0.73 |

### § 4.4 Image Data De-Noising and Cleaning Algorithm for Image Classification

Both the steps 452, 454 can utilize machine learning models for image classification. In an embodiment, the present disclosure includes various techniques to enhance image data cleanliness and improve quality for tasks related to image classification. These techniques can be used with any image-based file format 402, tool 404 used to process images, and the steps 452, 454. It encompasses three aspects, which can be used together or individually, including OCR, file size filtering, and image hashing.

### $4.4.1 OCR

OCR includes converting any text in images to a computer-readable text format, i.e., typed, handwritten, or printed text in images or video screenshots into machine-encoded text. For example, PDF documents can be image-based, but represent text documents. Conventionally, OCR is used to convert images to text and then the text is processed through DLP dictionaries. See, e.g., commonly-assigned U.S. Pat. No. 11,805,138, issued Oct. 31, 2023, and entitled “Data Loss Prevention on images,” the contents of which are incorporated by reference in their entirety. The present disclosure contemplates OCR with the multimodal DLP system 400 for enhancing processing and/or for improving efficiency, speed, etc.

In an embodiment, OCR can be used in training machine learning models. As is known in the art, supervised learning involves a training process where a machine learning model is trained with labeled samples. After training, the machine learning model is able to perform inferences or classifications in production. In the multimodal DLP system 400, one or more machine learning models can be used in the sensitive content identifier step 452 to classify an image as sensitive or not, and in the sensitive data classifier step 454, to classify an image into one of a plurality of super categories as well as into one or more sub-categories.

For both these tasks, classifying as sensitive/non-sensitive and for categories, there is a requirement for training data which is labeled. For example, a first set of documents each labeled as either sensitive or not, and a second set of documents labeled for categories (of course, this second set of documents can be the same as the first set, different, or include some of the same images). A key aspect of this training is that is does not require individual companies to provide their sensitive information. Rather, the trained machine learning models are trained across a whole set of the documents such as from public repositories, from the model creator, etc.

For example, the model creator can use its own internal documents for training. The model creator can be a SaaS provider, cloud service provider, etc., and has a large amount of internal documents and these are already labeled. The model creator can get documents from finance, HR, sales, engineering, etc. and those labels can be attached for the categories. In other embodiments, labeling for training documents can be performed using other machine learning techniques such as clustering, etc.

In an embodiment, OCR can be used to identify mislabeled samples in either or both of the first set or second sect of training documents. Here, the text can be extracted from labeled sample images and then verified against keywords associated with sensitive data categories. For example, examine whether the extracted text contains words such as ‘property,’ ‘asset,’ ‘seller,’ ‘buyer,’ or ‘purchase agreement’ for real estate documents. This can be extended to all of the super categories and the sub-categories in the sensitive data classifier step 454. An output of this OCR can be a suspect set of training documents that can be provided for user input. Output from this can be used to further refine the keywords as well as to relabel any of the suspect set of images.

OCR can also be used in the sensitive content identifier step 452. In an embodiment, classification of sensitive/non-sensitive can be performed in combination with categorization classification. For example, all HR documents are sensitive, etc. In another example, the classification of sensitive/non-sensitive can be performed in with a separate model from the categorization classification. In either case, the OCR can be used to identify mislabeled samples at for the classification of sensitive/non-sensitive. Here, there is a large pool of words for sensitive and non-sensitive.

A key aspect of this technique is it improves the training of the models for classification as the input data is cleaner with respect to labels.

### § 4.4.2 File Size Filtering

In various embodiments, the present disclosure can include a technique of filtering out images that are blurry, unreadable, etc. This filtering technique can be performed both the in first or second set of documents for training as well as in any inputs being analyzed in production by the multimodal DLP system 400. In particular, filtering can be performed based on file size or image resolution. Smaller image files are often blurry and challenging to visualize.

In the training data, the file size filtering can be used to exclude poor images from the first or second set of documents for training. In production, the file size filtering can be used exclude images from processing by the multimodal DLP system 400 where there is no risk due to the image not having any discernible content. In training, this approach improves the quality of the training data, and, in production, this approach improves the efficiency and resource cost of the multimodal DLP system 400.

### § 4.4.3 Image Hashing

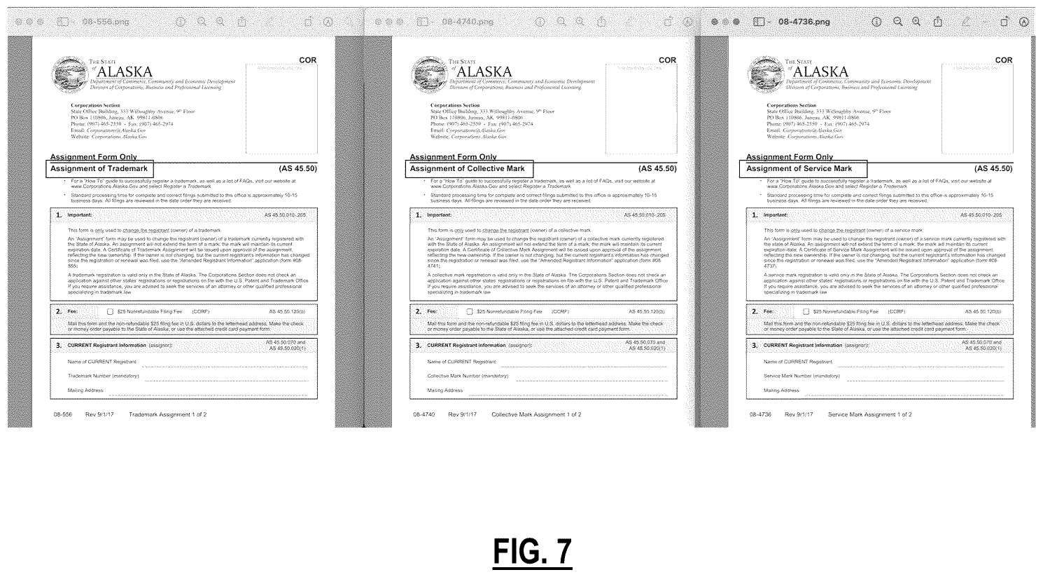

Also, the present disclosure can include imaging hashing which can detect identical or closely similar images in the training data, i.e., the first or second set of training data, and eliminate duplicates. FIG. 7 is a screenshot of three sample images that are closely similar to one another. In particular, these three sample images are government documents for Assignment of Trademark, Collective Mark, or Service Mark. That is, the highlighted portion in FIG. 7 shows the only difference between these three documents, i.e., the words Trademark, Collective Mark, or Service Mark before “Assignment of.” With image hashing, these three documents are detected as being closely similar to one another, and these three samples are grouped together as they exhibit high similarity with only subtle differences. To prevent data leakage issues, it's advisable to retain only one of them in the training data. In an embodiment, the imaging hashing can utilize ImageHash, available at pypi.org/project/ImageHash/.

### § 4.4.4 Data Cleaning

For the training data, the present disclosure can utilize the various approaches described herein for data cleaning. Some additional approaches for data cleaning on image files include removing observed duplicates as described above, removing logos, removing front pages or guidance (instruction) pages, and the like.

### § 4.5 Combination of LLM and Zero-Shot Classifier

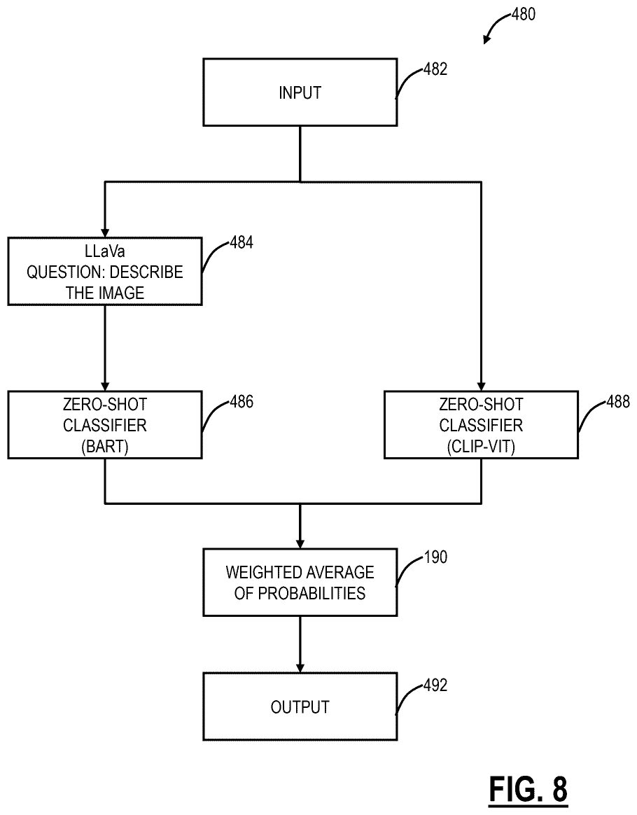

FIG. 8 is a flowchart of a process 480 for an example implementation of the sensitive data classifier step 454 using a combination of an LLM and zero-shot classifiers. The process 480 contemplates implementation as a method having steps, via computing resources configured to implement the steps, and as a non-transitory computer-readable medium with instructions that when executed cause one or more processors to implement the steps. The process 480 can be implemented with the multimodal DLP system 400, and practical implementations of the multimodal DLP system 400 and the processes 450, 480 can be through the network configurations 100A, 100B, 100C, and the like. That is, the process 480 contemplates use with any cybersecurity monitoring platform, appliance, service, etc.

The process 480 includes receiving an input (step 482) and both:
(1) processing the input with an LLM to describe the image (step 484) and processing the description with a zero-shot classifier (step 486). For example, LLaVa can be used as the LLM to describe the image and BART can be used as the zero-shot classifier.
(2) processing the input with a zero-shot classifier, such as CLIP-VIT (step 488).

The process 480 includes taking outputs of the two zero-shot classifier steps 486, 488, assigning a weighted average (step 490), and providing an output classification (step 492).

### § 4.6 Combination of CLIP Embedding and Supervised Learning Xgboost

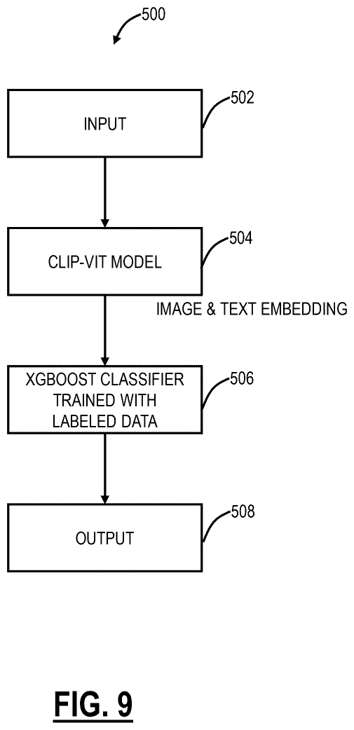

FIG. 9 is a flowchart of a process 500 for an example implementation of the sensitive content identifier step 452 using a combination of CLIP embedding and supervised learning XGboost. The process 500 contemplates implementation as a method having steps, via computing resources configured to implement the steps, and as a non-transitory computer-readable medium with instructions that when executed cause one or more processors to implement the steps. The process 500 can be implemented with the multimodal DLP system 400, and practical implementations of the multimodal DLP system 400 and the processes 450, 480, 500 can be through the network configurations 100A, 100B, 100C, and the like. That is, the process 500 contemplates use with any cybersecurity monitoring platform, appliance, service, etc.

The process 500 includes receiving an input (step 502), processing the input with a CLIP-VIT model (step 504) to obtain image and text embeddings, processing the image and text embeddings with an XGboost classifier that was trained with labeled data (step 506), and providing an output (step 508).

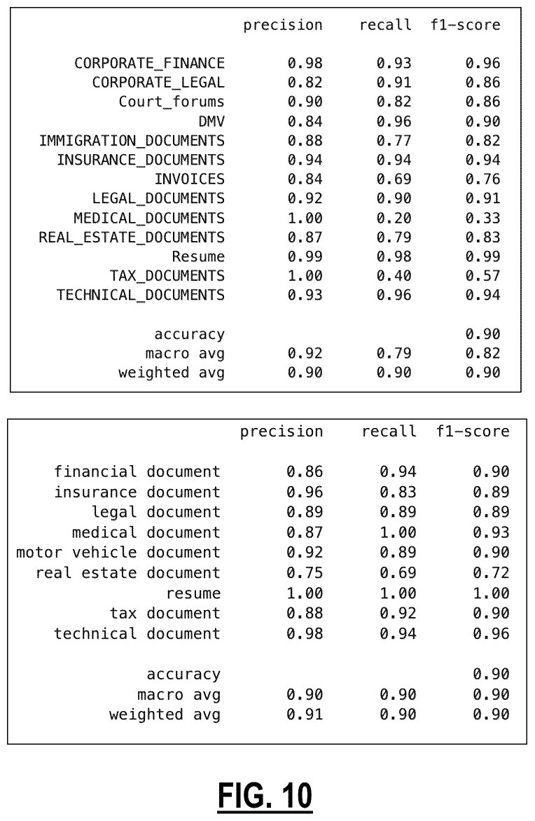

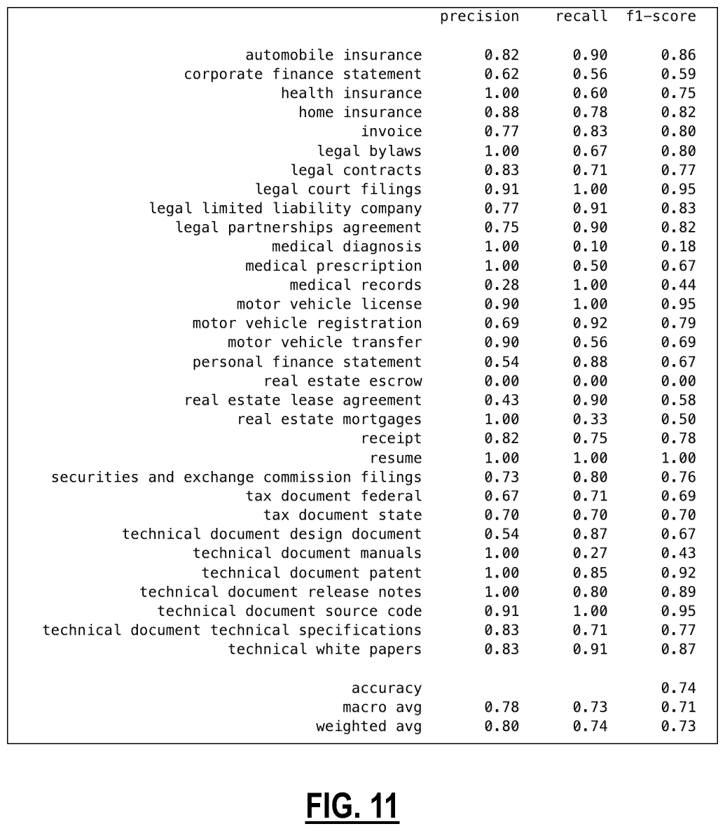

FIG. 10 is a table of examples of categorization results using the process 500. Here, the process 500 is configured to categorize the input into one of 13 categories, e.g., finance, legal, etc. Note, the high values for both precision and recall. FIG. 11 is a table of examples of sub-category results.

In various embodiments, the following models were used herewith:

| task | model |
|---|---|
| Content extraction | LLaVa |
| | LLaVa + RAG |
| | BLIP |
| | Video-LLaMA |
| | OCR |
| Embedding | TF-IDF |
| | Bert |
| | Clip-Vit |
| Classification | Bart zero-shot classifier |
| | Clip-Vit zero-shot classifier |
| | XGboost |

### § 4.7 Latency Reduction of LLMs by Model Compression

The following table illustrates some example models, associated performance, and cost, for implementing the sensitive data classifier step 454. LLAVA+Zero Shot method uses pre-trained model to do classification. Clip Base/Large method does embeddings. Then we split data into train/test and build ML classifier with the embedding feature vectors.

| | | | Accuracy | Accuracy | | |
|---|---|---|---|---|---|---|
| | Time to | | (in %) | (in %) | Prediction | Dollar |
| | load (in | | Train:Test | Train:Test | Time (in | cost (per |
| Model | secs) | Memory (in Gb) | 8:2 | 2:8 | secs) | image) |
| LLAVA + Zero Shot | 40 | 29 | 65 | 65 | 12.5 | $0.01 |
| Clip Base | 1.8 | 3.2 | 77 | 70 | 0.074 | $0.00007 |
| Clip Large | 3.5 | 3.6https://clip-as- | 90 | 85 | 0.1 | $0.0001 |
| | | service.jina.ai/user- | | | | |
| | | guides/benchmark/ | | | | |

§ 4.8 Multimodal DLP process

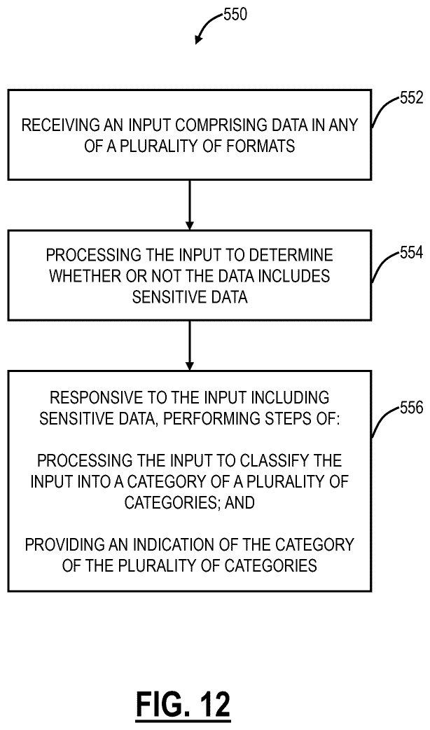

FIG. 12 is a flowchart of a process 550 for multimodal DLP. The process 550 contemplates implementation as a method having steps, via computing resources configured to implement the steps, and as a non-transitory computer-readable medium with instructions that when executed cause one or more processors to implement the steps. The process 550 can be implemented with the multimodal DLP system 400, and practical implementations of the multimodal DLP system 400 and the processes 450, 480, 500 550 can be through the network configurations 100A, 100B, 100C, and the like. That is, the process 550 contemplates use with any cybersecurity monitoring platform, appliance, service, etc.

The process 550 includes receiving an input comprising data in any of a plurality of formats (step 552); processing the input to determine whether or not the data includes sensitive data (step 554); and responsive to the input including sensitive data, performing steps of: processing the input to classify the input into a category of a plurality of categories; and providing an indication of the category of the plurality of categories (step 556).

The process 550 can further include, responsive to the input including non-sensitive data, providing an indication the data is non-sensitive, thereby either allowing the data in transit or not marking the data at rest. The process 550 can further include, responsive to the input including sensitive data, providing an indication of the category of the plurality of categories and a sub-category associated with the category.

The plurality of formats can include text formats, image formats, audio formats, video formats, source code, and a combination thereof. The processing the input to determine whether or not the data includes sensitive data can utilize (1) a Large Language Model (LLM) and embeddings and (2) a machine learning model configured for classification. The processing the input to classify the input into the category can utilize (1) a Large Language Model (LLM) and (2) a zero-shot classifier.

The processing the input to determine whether or not the data includes sensitive data and the processing the input to classify the input into the category both can utilize one or more machine learning models that were trained based on a set of training documents with labels. The process 550 can further include, prior to training the one or more machine learning models with the set of training documents with labels, identifying any mislabeled documents therein by performing Optical Character Recognition (OCR) and checking if associated keywords are present. The process 550 can further include, prior to training the one or more machine learning models with the set of training documents with labels, filtering out an images in the set of training documents with labels based on file size. The process 550 can further include, prior to training the one or more machine learning models with the set of training documents with labels, grouping images in the set of training documents with subtle differences based on a hash of the images.

### § 4.9 Multimodal DLP and Conventional DLP

The present disclosure presents various approaches for multimodal DLP with artificial intelligence. These techniques can be used in combination with existing DLP detection techniques, such as ones with DLP dictionaries. In an embodiment, the conventional DLP techniques can be used with the multimodal DLP with machine learning, to provide two answers which can be combined to give a final, more reliable answer (sensitive or not). In another embodiment, the multimodal DLP with machine learning and the conventional DLP techniques can be used to front end one another, i.e., either way, to reduce computational effort. For example, the sensitive content identifier step 452 can be used as a front end classifier to determine whether given content needs to be analyzed further, such as with DLP dictionaries, for improving efficiency and latency of DLP monitoring.

### § 4.10 Categorization

Conventional DLP approaches work by detecting specific pre-defined content whereas the approach described herein provides a classification and/or categorization of content. As described herein, the multimodal DLP with artificial intelligence process 450 can perform a classification with the sensitive content identifier step 452 that data is either sensitive or non-sensitive, and the sensitive data classifier step 454 can perform categorization into one of a plurality of categories. Advantages of this approach include the ability to detect classes and categories of documents without a need to provide sensitive data up-front, as well as improved accuracy, less false negatives or positives, and the like.

The categorization can be based on training as described herein. In an embodiment, the training can be performed by an entity hosting the model, referred to as a model creator. The model creator can use its own internal documents as well as publicly available documents in order to eliminate the need for companies to expose their sensitive documents. Specifically, the models are training on types of documents as opposed to specific content. In an embodiment, the categories can include immigration documents, corporate legal documents, court documents, legal documents, tax documents, insurance documents, invoice documents, resume documents, real estate documents, medical documents, technical documents, and finance documents. Of course, other categories are possible, based on the training data and associated labels. That is, the number of labels determines the number of categories.

### § 4.11 DLP Rules and Analytics

Again, the approach described herein can be used in combination with conventional DLP techniques, i.e., using dictionaries. This can enable a holistic approach for DLP monitoring in cybersecurity. Specifically, IT can gain insight into activity and spot issues where there are disconnects between data handling based on user function, in addition to stopping specific data from being exposed. With categories, DLP rules can be more than a single document contains sensitive information. Rather, there can be policies where someone's function is compared to their activities, e.g., someone in engineering should not be handling a large volume of HR documents and vice versa.

### CONCLUSION

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including software and/or firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the approaches may be used. For some of the embodiments described herein, a corresponding device in hardware and optionally with software, firmware, and a combination thereof can be referred to as “circuitry configured or adapted to,” “logic configured or adapted to,” “a circuit configured to,” “one or more circuits configured to,” etc. perform a set of operations, steps, methods, processes, algorithms, functions, techniques, etc. on data as described herein for the various embodiments.

Moreover, some embodiments may include a non-transitory computer-readable storage medium having computer-readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a Read-Only Memory (ROM), a Programmable Read-Only Memory (PROM), an Erasable Programmable Read-Only Memory (EPROM), an Electrically Erasable Programmable Read-Only Memory (EEPROM), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. Further, the various elements, operations, steps, methods, processes, algorithms, functions, techniques, etc. described herein contemplate use in any and all combinations with one another, including individually as well as combinations of less than all of the various elements, operations, steps, methods, processes, algorithms, functions, techniques, etc.

What is claimed is:

1. A method for multimodal Data Loss Protection (DLP) comprising steps of:
receiving an input comprising data in any of a plurality of formats;
processing the input to determine whether or not the data includes sensitive data; and
responsive to the input including sensitive data, performing steps of:
processing the input to classify the input into a category of a plurality of categories; and
providing an indication of the category of the plurality of categories.

2. The method of claim 1, wherein the steps further include:
responsive to the input including non-sensitive data, providing an indication the data is non-sensitive, thereby either allowing the data in transit or not marking the data at rest.

3. The method of claim 1, wherein the steps further include:
responsive to the input including sensitive data, providing an indication of the category of the plurality of categories and a sub-category associated with the category.

4. The method of claim 1, wherein the plurality of formats include text formats, image formats, audio formats, video formats, source code, and a combination thereof.

5. The method of claim 1, wherein the processing the input to determine whether or not the data includes sensitive data utilizes (1) a Large Language Model (LLM) and embeddings and (2) a machine learning model configured for classification.

6. The method of claim 1, wherein the processing the input to classify the input into the category utilizes (1) a Large Language Model (LLM) and (2) a zero-shot classifier.

7. The method of claim 1, wherein the processing the input to determine whether or not the data includes sensitive data and the processing the input to classify the input into the category both utilize one or more machine learning models that were trained based on a set of training documents with labels.

8. The method of claim 7, wherein the steps further include:
prior to training the one or more machine learning models with the set of training documents with labels, identifying any mislabeled documents therein by performing Optical Character Recognition (OCR) and checking if associated keywords are present.

9. The method of claim 7, wherein the steps further include:
prior to training the one or more machine learning models with the set of training documents with labels, filtering out an images in the set of training documents with labels based on file size.

10. The method of claim 7, wherein the steps further include:
prior to training the one or more machine learning models with the set of training documents with labels, grouping images in the set of training documents with subtle differences based on a hash of the images.

11. A non-transitory computer-readable medium comprising instructions that, when executed, cause one or more processors to perform steps of:
receiving an input comprising data in any of a plurality of formats;
processing the input to determine whether or not the data includes sensitive data; and
responsive to the input including sensitive data, performing steps of:
processing the input to classify the input into a category of a plurality of categories; and
providing an indication of the category of the plurality of categories.

12. The non-transitory computer-readable medium of claim 11, wherein the steps further include:
responsive to the input including non-sensitive data, providing an indication the data is non-sensitive, thereby either allowing the data in transit or not marking the data at rest.

13. The non-transitory computer-readable medium of claim 11, wherein the steps further include:
responsive to the input including sensitive data, providing an indication of the category of the plurality of categories and a sub-category associated with the category.

14. The non-transitory computer-readable medium of claim 11, wherein the plurality of formats include text formats, image formats, audio formats, video formats, source code, and a combination thereof.

15. The non-transitory computer-readable medium of claim 11, wherein the processing the input to determine whether or not the data includes sensitive data utilizes (1) a Large Language Model (LLM) and embeddings and (2) a machine learning model configured for classification.

16. The non-transitory computer-readable medium of claim 11, wherein the processing the input to classify the input into the category utilizes (1) a Large Language Model (LLM) and (2) a zero-shot classifier.

17. The non-transitory computer-readable medium of claim 11, wherein the processing the input to determine whether or not the data includes sensitive data and the processing the input to classify the input into the category both utilize one or more machine learning models that were trained based on a set of training documents with labels.

18. The non-transitory computer-readable medium of claim 17, wherein the steps further include:
prior to training the one or more machine learning models with the set of training documents with labels, identifying any mislabeled documents therein by performing Optical Character Recognition (OCR) and checking if associated keywords are present.

19. The non-transitory computer-readable medium of claim 17, wherein the steps further include:
prior to training the one or more machine learning models with the set of training documents with labels, filtering out an images in the set of training documents with labels based on file size.

20. The non-transitory computer-readable medium of claim 17, wherein the steps further include:
prior to training the one or more machine learning models with the set of training documents with labels, grouping images in the set of training documents with subtle differences based on a hash of the images.
